(19) United States
(12) Patent Application Publication
(10) Pub. No.: US 2024/0265283 A1
(43) Pub. Date: Aug. 8, 2024

(54) INFORMATION PROCESSING APPARATUS, INFORMATION PROCESSING METHOD, AND PROGRAM

(71) Applicant: Nippon Telegraph and Telephone Corporation, Tokyo (JP)

(72) Inventors: Ryosuke SATO, Musashino-shi, Tokyo (JP); Kei TAKESHITA, Musashino-shi, Tokyo (JP); Atsushi TAKADA, Musashino-shi, Tokyo (JP); Mizuto NAKAMURA, Musashino-shi, Tokyo (JP)

(21) Appl. No.: 18/562,789

(22) PCT Filed: May 24, 2021
(86) PCT No.: PCT/JP2021/019524

§ 371 Date: Nov. 20, 2023

(51) Int. Cl. G06N 7/01

(52) U.S. Cl. CPC G06N 7/01

(57) ABSTRACT

An information processing device 1 detects data errors in a Bayesian network. The information processing device 1 includes a calculation unit 12 that calculates Kendall's coefficient of concordance for a determination tendency of each node based on observed information input to nodes in the Bayesian network; and an output unit 13 that outputs a determination result that the data includes an error when the Kendall's coefficient of concordance is lower than a threshold. The calculation unit 12 obtains a ranking of a posterior probability value of a child node for each node in the Bayesian network based on the observed information, and calculates Kendall's coefficient of concordance for the obtained ranking.

### TECHNICAL FIELD

The present invention relates to an information processing device, an information processing method, and a program.

### BACKGROUND ART

Artificial intelligence for IT operations (AIOps) is known for achieving automation and efficiency of system operations by causing AI to learn various types of data used in system operations. System operations involve accountability for determination, but since AI may be a black box model, it is necessary to secure explanatory information of the determination by AIOps.

For example, an overview of the structure for determination (comprehensive explanatory information) can be indicated by a Bayesian network that simulates the flexible judgment of an experienced operator. The Bayesian network can design a determination model that reflects human experience (domain knowledge) with a graphical model based on a node (determination element), an edge (relationship between determination elements), and a conditional probability table (degree of influence of determination elements). With the Bayesian network, unobserved information can be inferred by probabilistic computation based on observed information, and the validity of the AI output can be verified. Moreover, details (local explanatory information) of the basis for determination individually made by AI can be generated using SHapley Additive exPlanations (SHAP).

### CITATION LIST

### Non Patent Literature

Non Patent Literature 1: HUGIN EXPERT, “Building a Bayesian Network”, <URL: https://hugin.com/wp-content/uploads/2016/05/Building-a-BN-Tutorial.pdf>

### SUMMARY OF INVENTION

### Technical Problem

Data input to a Bayesian network is often input from the system as part of workflow automation. However, there are cases in which the system data itself is input manually as the input source, and with the potential for human error, there is a risk of erroneous data being input to the Bayesian network. Maintenance of the environment surrounding the Bayesian network is necessary by finding erroneous data and prompting its correction.

Examples of methods for detecting a data error include a parity bit and a check sum. Nodes in a Bayesian network are expressed by a combination of discrete values (0, 1, 2, etc.), but since the values are logically meaningful for each Bayesian network, the consistency rule cannot be mechanically defined like the parity bit.

A local outlier factor (LOF) is a method for detecting an outlier from a data group, but in general, the node value range of a Bayesian network is narrow at about 0 to 10, and the difference is not large enough for an outlier to be considered as such.

The present invention has been made in view of the above points, and an object thereof is to detect data errors.

### Solution to Problem

An aspect of the present invention is an information processing device that detects a data error in a Bayesian network, the information processing device including: a calculation unit that calculates Kendall's coefficient of concordance for a determination tendency of each node in the Bayesian network based on input data; and an output unit that outputs a determination result that the data includes an error when the Kendall's coefficient of concordance is lower than a threshold.

An aspect of the present invention is an information processing method that detects a data error in a Bayesian network, wherein a computer calculates Kendall's coefficient of concordance for a determination tendency of each node in the Bayesian network based on input data; and outputs a determination result that the data includes an error when the Kendall's coefficient of concordance is lower than a threshold.

### Advantageous Effects of Invention

Data errors can be detected by the present invention.

### BRIEF DESCRIPTION OF DRAWINGS

FIG. 1 is a diagram illustrating an example of a Bayesian network.

FIG. 2 is a functional block diagram illustrating an example of a configuration of an information processing device according to the present embodiment.

FIG. 3 is a diagram illustrating an example of a Bayesian network.

FIG. 4 is a diagram illustrating an example of ranking of a posterior probability value of the child node for each parent node.

FIG. 5 is a flowchart illustrating an example of a processing procedure of the information processing device according to the present embodiment.

FIG. 6 is a diagram illustrating an example of a hardware configuration of the information processing device.

### DESCRIPTION OF EMBODIMENTS

Hereinafter, an embodiment of the present invention will be described with reference to the drawings.

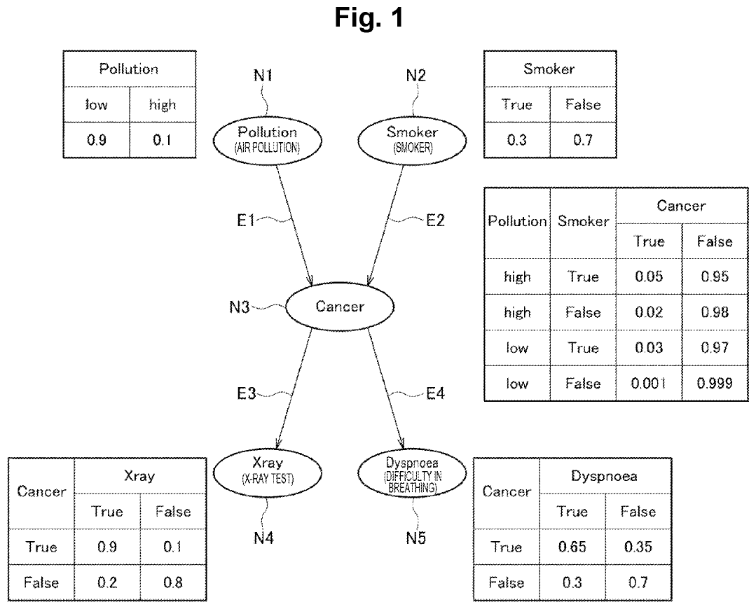

There follows a brief description of a Bayesian network with reference to FIG. 1. The Bayesian network in FIG. 1 is an example of a Bayesian network relating to cancer diagnosis. The Bayesian network in FIG. 1 includes five nodes N1 to N5; four edges E1 to E4; and a conditional probability table (CPT) for each node N1 to N5. A node indicates a determination element, and an edge indicates a causal relationship between determination elements. The source of the arrow of the edge is a parent node, and the destination of the arrow is a child node. The causal relationship between the nodes can be created with the knowledge of an experienced operator. In the example in FIG. 1, the nodes N1 and N2 are parent nodes of the node N3. The node N3 is a parent node of the nodes N4 and N5. A CPT indicates the degree of causal relationship between the determination elements. The CPT is manually calculated, for example, based on statistical information of data. When the observed information (data) is input to the parent nodes N1 and N2, probability values of the unobserved nodes N3, N4, and N5 are obtained. In the example in FIG. 1, Cancer in the node N3 can be inferred from Pollution in the node N1 and the state (value) of Smoker in the node N2. For example, in the CPT at the node N3 in FIG. 1, if Pollution=high and Smoker=True, the probability value for Cancer is 0.05; and if Pollution=low and Smoker=False, the probability value for Cancer is 0.001.

By making it possible to verify AI determination and explain the reason for the determination with a Bayesian network that simulates the flexible judgment of an experienced operator, AI can be safely incorporated in network operations.

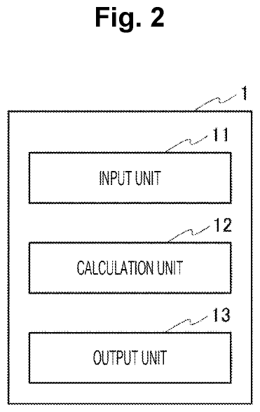

Next, an example configuration of the information processing device 1 according to the embodiment will be described with reference to FIG. 2. The information processing device 1 illustrated in FIG. 2 includes an input unit 11, a calculation unit 12, and an output unit 13.

The input unit 11 inputs information for obtaining a determination tendency of a parent node group into which observed information has been input. For example, the input unit 11 inputs a posterior probability value of the child node with respect to the parent node, based on the observed information input to the parent node. The posterior probability value can be calculated from the observed information input to the parent node and unobserved information of the child node calculated in the Bayesian network.

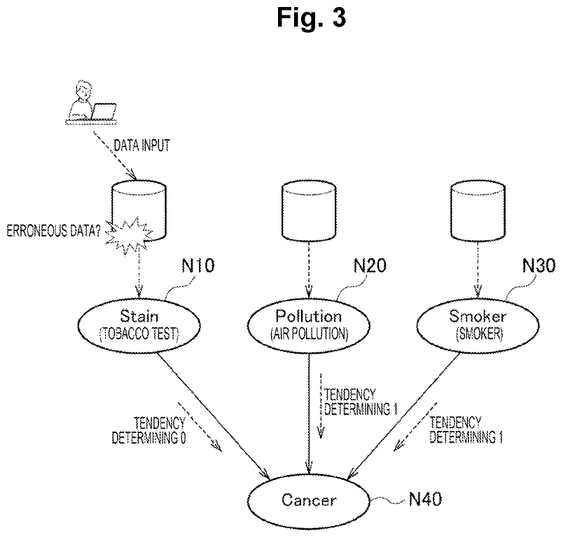

In the example of a Bayesian network in FIG. 3, observed information is input from a system to nodes N10, N20, and N30. A probability value of a node N40 is obtained based on the observed information input to the nodes N10, N20, and N30. In the example in FIG. 3, it is assumed that the data of the system that inputs observed information to the node N10 is data that is manually input to the system, and there is a possibility that the data includes an error.

For each of the nodes N10, N20, and N30, the input unit 11 inputs a posterior probability value of the child node N40 based on the input observed information. For the node N10, the determination element of which is Stain, the input unit 11 inputs a posterior probability value P(Cancer=0|Stain=0) with which Cancer=0 when Stain=0; and a posterior probability value P(Cancer=1|Stain=0) with which Cancer=1 when Stain=0. For the node N20, the determination element of which is Pollution, the input unit 11 inputs a posterior probability value P(Cancer=0|Pollution=1) with which Cancer=0 when Pollution=1; and a posterior probability value P(Cancer=1|Pollution=1) with which Cancer=1 when Pollution=1. For the node N30, the determination element of which is Smoker, the input unit 11 inputs a posterior probability value P(Cancer=0|Smoker=1) with which Cancer=0 when Smoker=1; and a posterior probability value P(Cancer=1|Smoker=1) with which Cancer=1 when Smoker=1. With a combination of the values of the parent node, different values are input from the system every time a workflow is executed. The above describes an example in which Stain=0, Pollution=1, and Smoker=1 are input to the Bayesian network and calculated.

The calculation unit 12 quantifies the consistency between items of observed information by calculating Kendall's coefficient of concordance with respect to the determination tendency of the parent node group. Specifically, the calculation unit 12 obtains a ranking of the posterior probability value of the child node for each parent node, calculates Kendall's coefficient of concordance using the ranking between the parent nodes, and quantifies the consistency between the items of observed information.

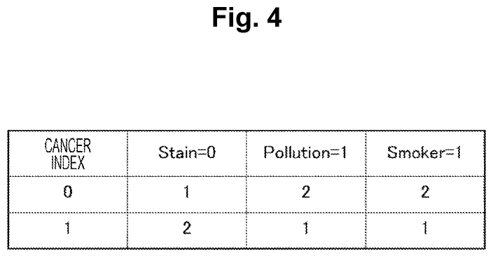

FIG. 4 illustrates an example in which a ranking of the posterior probability value of the child node is obtained for each of the parent nodes N10, N20, and N30 in FIG. 3. It is assumed that the posterior probability value of the child node with respect to the parent node has a relationship of the following equation.

$$\\ \begin{matrix}P ( Cancer = 0 \vert Stain = 0 ) > P ( Cancer = 1 \vert Stain = 0 ) & [ Equation 1 ]\end{matrix}$$

$$\\ P ( Cancer = 1 \vert Pollution = 1 ) > P ( Cancer = 0 \vert Pollution = 1 )$$

$$\\ P ( Cancer = 1 \vert Smoker = 1 ) > P ( Cancer = 0 \vert Smoker = 1 )$$

For the node N10, the posterior probability value P(Cancer=0|Stain=0) is greater than the posterior probability value P(Cancer=1|Stain=0), and thus the ranking for Stain=0 places Cancer=0 in first position and Cancer=1 in second position.

For the node N20, the posterior probability value P(Cancer=0|Pollution=1) is greater than the posterior probability value P(Cancer=1|Pollution=1), and thus the ranking for Pollution=1 places Cancer=1 in first position and Cancer=0 in second position.

For the node N30, the posterior probability value P(Cancer=0|Smoker=1) is greater than the posterior probability value P(Cancer=1|Smoker=1), and thus the ranking for Smoker=1 places Cancer=1 in first position and Cancer=0 in second position.

In addition, in a case where the child node has three or more values, a ranking of third position or lower is also obtained for each parent node.

The calculation unit 12 obtains a posterior probability value ranking of the child node for each parent node, and obtains Kendall's coefficient of concordance for the ranking between the parent nodes. Kendall's coefficient of concordance W is obtained using the following equation.

$$\\ \begin{matrix}{R}_{i} = {\sum }_{j = 1}^{m} {r}_{ij} , \overline{R} = \frac{1}{n} {\sum }_{i = 1}^{n} {R}_{i} , S = {\sum }_{i = 1}^{n} {( {R}_{i} - \overline{R} )}^{2} & [ Equation 2 ]\end{matrix}$$

$$\\ W = \frac{12 S}{{m}^{{}_{} 2} n ( {n}^{{}_{} 2} - 1 )}$$

Here, i is each value (for example, Cancer=0, Cancer=1) of a child node; j is a parent node (for example, the nodes N10, N20, and N30); r_{iJ} is a ranking value (for example, first or second position) of the value i of the child node by the parent node j; n is the number of child node values; m is the number of parent nodes; Ri is the sum of ranks for each value i of the child node; R (overbar) is an average of the sums of ranks; and S is a sum of squares S related to the ranks.

When the determination between the parent nodes is consistent, Kendall's coefficient of concordance W approaches 1, and when the determination is inconsistent, Kendall's coefficient of concordance W approaches 0.

When the numerical value of the consistency (Kendall's coefficient of concordance W) obtained by the calculation unit 12 is lower than an arbitrary threshold, the output unit 13 outputs a determination result indicating the possibility that the input observed information includes an error, and prompts its correction. For example, the output unit 13 evaluates the direction of the action given to the child node of the parent node from the posterior probability value, deems that there is a high possibility of an error in the observed information input to a node that has a determination tendency different from the others, and prompts its correction.

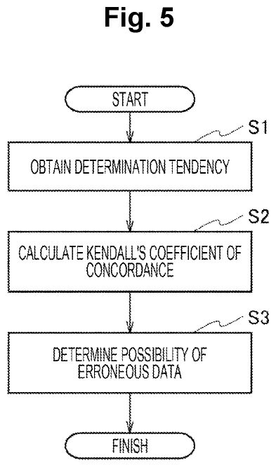

Next, an example of a processing procedure of the information processing device 1 according to the present embodiment will be described with reference to the flowchart in FIG. 5.

In step S1, the information processing device 1 obtains a determination tendency of the parent node group. Specifically, the information processing device 1 inputs the posterior probability value of the child node for each parent node, and obtains a ranking of the posterior probability value of the child node for each parent node.

In step S2, the information processing device 1 calculates Kendall's coefficient of concordance for the determination tendency of the parent node group. Specifically, the information processing device 1 calculates Kendall's coefficient of concordance for the degree of coincidence of the ranking obtained in step S1.

In step S3, the information processing device 1 determines the possibility that erroneous data is present. Specifically, the information processing device 1 compares the Kendall's coefficient of concordance calculated in step S2 with a predetermined threshold, and when the Kendall's coefficient of concordance is lower than the predetermined threshold, outputs a determination result indicating the possibility that the data includes an error. At this time, the information processing device 1 may evaluate the direction of the action given to the child node of the parent node from the posterior probability, and indicate the possibility of an error in the data input to a node that has a determination tendency different from the others.

As described above, the information processing device 1 according to the present embodiment includes the calculation unit 12 that calculates Kendall's coefficient of concordance for the determination tendency of each node based on the observed information input to the nodes in the Bayesian network; and the output unit 13 that outputs a determination result that the data includes an error when the Kendall's coefficient of concordance is lower than the threshold. The calculation unit 12 obtains a ranking of the posterior probability value of the child node for each node based on the observed information, and calculates Kendall's coefficient of concordance for the ranking obtained. This enables erroneous data to be detected, prompts the correction of the erroneous data, and enables maintenance of the environment surrounding the Bayesian network.

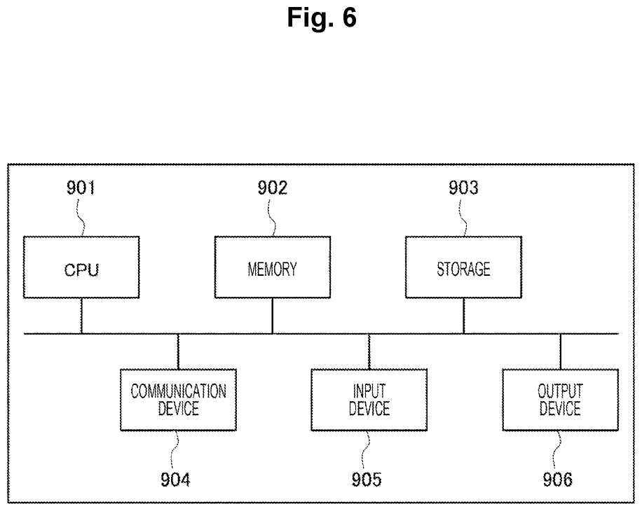

For example, as illustrated in FIG. 6, a general-purpose computer system including a central processing unit (CPU) 901, a memory 902, a storage 903, a communication device 904, an input device 905, and an output device 906 can be used as the information processing device 1 described above. In this computer system, the CPU 901 executes a predetermined program loaded on the memory 902, thereby implementing the information processing device 1. This program can be recorded on a computer-readable recording medium such as a magnetic disk, an optical disc, or a semiconductor memory, or can be distributed via a network.

### REFERENCE SIGNS LIST

1 Information processing device
11 Input unit
12 Calculation unit
13 Output unit

1. An information processing device that detects a data error in a Bayesian network, the information processing device comprising:
a calculation unit, including one or more processors, configured to calculate Kendall's coefficient of concordance for a determination tendency of each node in the Bayesian network based on input data; and
an output unit, including one or more processors, configured to output a determination result that the input data includes an error when the Kendall's coefficient of concordance is lower than a threshold.

2. The information processing device according to claim 1, wherein the calculation unit is configured to:
obtain a ranking of a posterior probability value of a child node for each node in the Bayesian network based on the input data, and
calculate the Kendall's coefficient of concordance for the obtained ranking.

3. The information processing device according to claim 2, wherein
when the Kendall's coefficient of concordance is lower than the threshold, the output unit is configured to output a determination result that the input data to a node with a determination tendency different from other nodes includes an error.

4. An information processing method that detects a data error in a Bayesian network, the information processing method being performed by a computer and comprising:
calculating Kendall's coefficient of concordance for a determination tendency of each node in the Bayesian network based on input data; and
outputting a determination result that the input data includes an error when the Kendall's coefficient of concordance is lower than a threshold.

5. The information processing method according to claim 4, further comprises:
obtaining a ranking of a posterior probability value of a child node for each node in the Bayesian network based on the input data, and
calculating the Kendall's coefficient of concordance for the obtained ranking.

6. The information processing method according to claim 5, wherein
when the Kendall's coefficient of concordance is lower than the threshold outputting a determination result that the input data to a node with a determination tendency different from other nodes includes an error.

7. A program causing a computer to operate as each unit of the information processing device according to claim 1.
